(19) United States
(12) Patent Application Publication
(10) Pub. No.: US 2020/0309571 A1
(43) Pub. Date: Oct. 1, 2020

(54) GROWTH AND OPTIMIZATION OF METAL-ORGANIC FRAMEWORK THIN FILMS ON A CONDUCTIVE METAL OXIDE FOR GAS SENSOR APPLICATIONS

(71) Applicant: United States Department of Energy, Washington, DC (US)

(72) Inventors: Ki-Joong Kim, Upper Saint Clair, PA (US); Paul R Ohodnicki, Allison Park, PA (US); Scott Evan Crawford, West Mifflin, PA (US)

(21) Appl. No.: 16/368,257

(22) Filed: Mar. 28, 2019

(51) Int. Cl. G01D 5/26; G01N 21/552; G01N 29/02

(52) U.S. Cl. CPC G01D 5/268; G01N 29/022; G01N 21/554

(57) ABSTRACT

A system and method for forming a sensor. The method includes forming a template and forming a hydroxy double salt layer intermediate. The method further includes forming a metal-organic framework (MOF) film. A method of forming a sensor. One embodiment of the method includes forming a template and forming a hydroxy double salt layer intermediate. The method further includes forming a metal-organic framework (MOF) film and forming a hybrid MOF/conducting metal oxide structure.

### GOVERNMENT INTEREST

The United States Government has rights in this invention pursuant to the employer-employee relationship of the Government to the inventors as U.S. Department of Energy employees and site-support contractors at the National Energy Technology Laboratory.

### FIELD OF THE INVENTION

The disclosure provides a system and method for rapid, ambient temperature growth of metal-organic framework (MOF) films for gas sensor applications. More specifically, the embodiments relate to the growth of MOF films on advanced sensor devices such as distributed optical fiber and passive wireless such as surface acoustic wave-based sensors.

### BACKGROUND

The disclosure provides a system and method for rapid, ambient temperature growth of metal-organic framework (MOF) films for gas sensor applications. More specifically, one or more embodiments relate to growth of MOF films on advanced sensor devices such as distributed optical fiber and passive wireless such as surface acoustic wave based sensors.

MOF thin films have emerged as particularly attractive candidates for gas sensing applications due to their tunable reactivity and pore size, enabling them to be rationally designed to selectively absorb specific gasses of interest. MOFs are especially appealing due to their high selectivity and capacity for energy-relevant gasses such as carbon dioxide and methane. A critical step towards the development of MOF thin film devices is the ability to efficiently and reliably incorporate high-quality MOF layers onto a range of substrates, such as optical fibers or piezoelectric crystals.

There are several techniques that have been established for MOF thin film growth. Typically, the substrate is modified with a “self-assembly” layer, such as an organic linking molecular or metal oxide film, to which the MOF will adhere during crystal growth. Following the substrate surface modification, a MOF layer may be grown using layer-by-layer deposition, a polymer template, solvothermal deposition, electrochemistry, and/or dip-coating. Conventional techniques for MOF film deposition and integration suffer from long and complex synthesis processes which may also involve elevated temperatures or other complicating factors. For uniform, scalable, and rapid deposition of MOF-based materials onto advanced sensor platforms, novel deposition methods and techniques are paramount to enable manufacturable sensor devices that take advantage of platform characteristics.

FIG. 1 depicts prior art methods of forming MOFs indicating that, in one or more instance, MOFs are structurally engineered nanoporous materials synthesized in thin film form through multi-step layer-by-layer deposition processes. FIG. 1 further indicates that the method requires specific chemical boding and/or long reaction times, on the order of days or even longer.

However, these techniques are often inconvenient due to either their very long reaction times (typically requiring up to several days, depending upon the particular synthesis and/or the reaction conditions such as solvent, temperature, and concentration), heating requirements, equipment costs, and/or poor control over crystal coverage and morphology. In addition to this, the ability to incorporate MOF thin films uniformly into various devices such as optical fibers and piezoelectric crystals while controlling experimental variables including crystal size and packing density has been elusive. For optical fiber-based sensors envisioned for subsurface or natural gas pipeline monitoring applications, for example, km-range lengths of fiber must be coated in a uniformly with such thin film sensing layers and in a scalable manner.

There is an urgent need in the energy sector to develop gas sensors capable of detecting relevant gases under high pressure, temperature, and corrosion conditions as well as over km-range distances. It should be appreciated that incorporating MOF thin films on advanced sensing platforms such as optical fibers is not as simple as normal planar substrates and must be implemented in a way that is reproducible and scalable. For example, previously known MOF thin film processes require long reaction time (several days or more) and/or specific chemical bonding to achieve high-quality, using techniques such as “self-assembly monolayer” through repetitive deposition of metal salt ions and an organic linking molecule followed by each subsequent MOF layer using layer-by-layer deposition.

The following issued patents and patent applications are incorporated herein by reference in their entity:
U.S. Patent Application No. 2018/0011010 A1 to Chang et al.

The following articles are incorporated herein by reference in their entity:
Rapid, Selective, Ambient Growth and Optimization of Copper Benzene-1,3,5-Tricarboxylate (Cu-BTC) Metal-Organic Framework Thin Films on a Conductive Metal Oxide by Crawford et al., Crystal Growth & Design, 2018, 18, 2924-2931.
Facile Conversion of Hydroxy Double Salts to Metal-Organic Frameworks Using Metal Oxide Particles and Atomic Layer Deposition Thin-Film Templates by Zhao et al., Journal of American Chemical Society, 2015, 137, 13756-13759.
Copper Benzenetricarboxylate Metal-Organic Framework Nucleation Mechanism on Metal Oxide Powders and Thin Films formed by Atomic Layer Deposition by Lemaire et al., ACS Applied Materials & Interfaces, 2016, 8, 9514-9522.

These and other objects, aspects, and advantages of the present disclosure will become better understood with reference to the accompanying description and claims.

### SUMMARY

One or more embodiments relate to a method of forming a sensor, used in a distributed optical fiber sensor. The method includes forming a template and forming a hydroxy double salt layer intermediate. The method further includes forming a metal-organic framework (MOF) film. A method of forming a sensor. One embodiment of the method includes forming a template and forming a hydroxy double salt layer intermediate. The method further includes forming a metal-organic framework (MOF) film and forming a hybrid MOF/conducting metal oxide structure

Still other embodiments relate to a system and method for forming a sensor. The method includes forming a conductive metal oxide layer on the template. The conductive metal oxide layer on the template is exposed to a metal salt solution, forming a hydroxy double salt layer on the template. The hydroxy double salt layer on the template is incubated in an organic linker solution, forming a metal-organic framework (MOF) film on the template.

Embodiments of the system and method may include forming at least one of the hydroxy double salt layer intermediates and the MOF film on the template. Further, the conductive metal oxide layer may be formed prior to forming the hydroxy double salt layer intermediate.

One or more embodiments include incubating the hydroxy double salt layer intermediate in metal salt ion solution forming the hydroxy double salt layer intermediate and the MOF film growth after exposure to organic linker solution at room temperature, where the room temperature ranges between about 60 degrees to about 80 degrees Fahrenheit. Embodiments may further include forming the hydroxy double salt layer intermediate and the MOF film on the template during a short reaction time, where the short reaction time is a few tens of minutes. Embodiments may include the MOF film being uniform, continuous with a controllable thickness; and/or forming the MOF film in a predetermined pattern.

One or more embodiments contemplates leveraging the hybrid MOF/conducting metal oxide structure for optical sensing. More specifically, these embodiments use only a portion of total MOF film when forming the hybrid MOF/conducting metal oxide structure.

Various embodiments of the methodology disclosed are further demonstrated and described in the following description.

### BRIEF DESCRIPTION OF THE DRAWINGS

FIG. 1 depicts prior art methods of forming MOFs indicating that MOFs are structurally engineered nanoporous materials;

FIG. 2 depicts a flow chart illustrating a method of forming a sensor;

FIG. 3 illustrates a series of steps in forming MOF films;

FIG. 4 depict images illustrating MOF film growth;

FIG. 5 depicts a graph illustrating x-ray diffraction patterns confirming the film and powder structure;

FIGS. 6A-6B depicts images of an aluminum-doped zinc oxide (AZO) layer by exposure to different salts along with x-ray diffraction patterns confirming structure, while FIG. 6C depicts a graph illustrating XRD patterns of hydroxy double layers formed by exposure to AZO-CuCl₂, AZO-CuBr₂, AZO-Cu(NO₃)₂, AZO-Cu(CH₃COO)₂ and AZO-Cu(SO₄)₂, and Cu-BTC MOF structures following exposure to BTC organic linker solution;

FIG. 7 depicts images illustrating different growth conditions; and

FIG. 8 depicts a graph illustrating gas sensing responses of a MOF thin film in response to varying levels of CO₂.

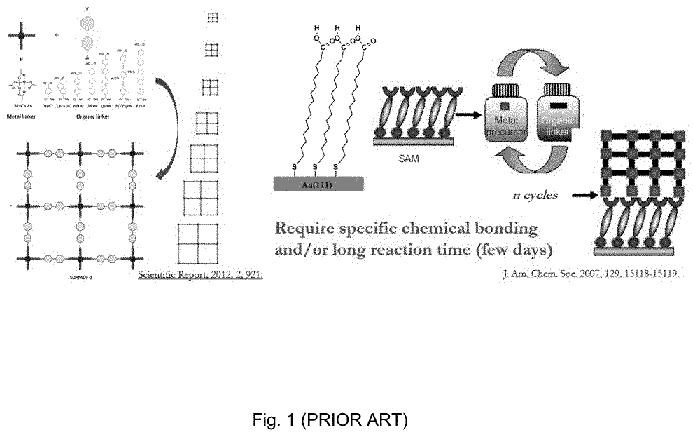

### DETAILED DESCRIPTION

The following description is provided to enable any person skilled in the art to use the invention and sets forth the best mode contemplated by the inventor for carrying out the invention. Various modifications, however, will remain readily apparent to those skilled in the art, since the principles of the present invention are defined herein specifically to provide a system and methodology for rapid, selective and room temperature growth of MOF thin films on conductive metal oxides for gas sensor application. The method or process uses the conductive metal oxide itself as a template for metal-organic framework (MOF) film growth by sequential exposure to the metal cation and then the organic linker solutions.

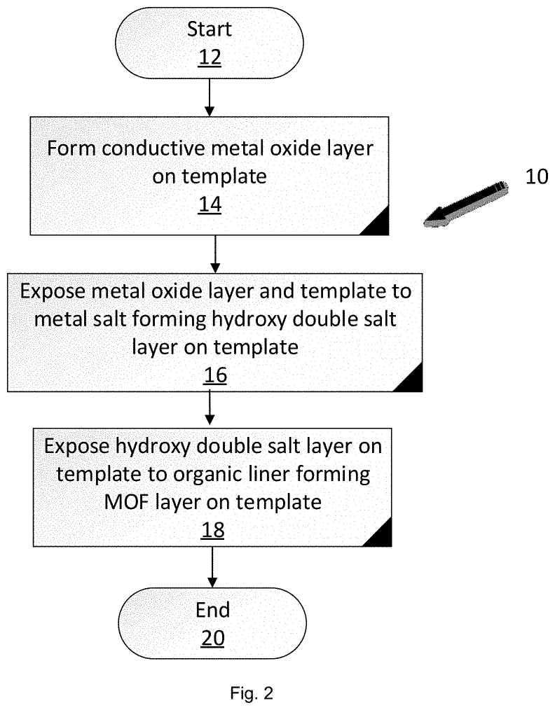

Embodiments of the present invention relate to the rapid, selective, and room temperature growth of MOF thin films on conductive metal oxide templates for gas sensor applications, used in a distributed optical fiber sensor for example. FIG. 2 depicts a flow chart illustrating a method of forming a MOF sensor, generally designated 10. The method 10 starts at step 12 and includes selecting or forming a template. Method 10 further includes forming a conductive metal oxide layer on the template, step 14. FIG. 2 further illustrates exposing the conductive metal oxide layer on the template to a metal salt solution, forming a hydroxy double salt layer on the template, step 16. Finally, FIG. 2 illustrates incubating the hydroxy double salt layer on the template forming a metal-organic framework (MOF) film on the template, step 18 then ends at step 20.

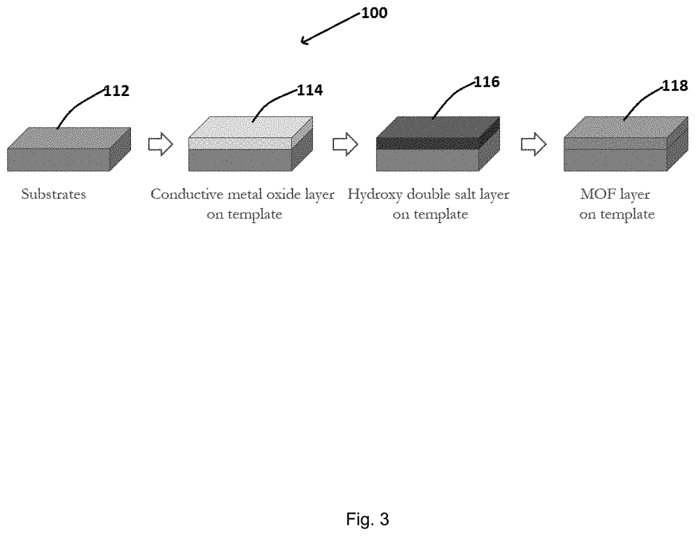

In one exemplary embodiment illustrated in FIG. 3, process 100 includes forming or selecting a substrate 112. A conductive metal oxide layer 114 is formed on the template. The conductive metal oxide 114 may be prepared by either a sol-gel method or a sputtering method and the like. The conductive metal oxide 114 and template are then exposed to one or more different metal salt ion solutions, forming hydroxy double salt layer 116 on the template. The hydroxy double salt layer 116 on the template is followed by incubating in an organic ligand solution forming the MOF layer 118 on the template.

MOF films grow only on the conductive metal oxide template, occur at room temperature, and require a reaction time on the order of a few tens of minutes. The hydroxy double salt structure and corresponding MOF film vary dramatically depending upon the choice of metal salt anion; indeed, the average crystal size varies by over 1 micron when chloride is used versus nitrate. The addition of acid to the MOF growth solution hinders MOF formation, and acid and base addition can be used to alter the MOF crystal size by several hundred nanometers.

Embodiments demonstrate that the MOF morphology may be altered when using more acidic polar aprotic solvents such as acetone or acetonitrile versus the more basic dimethyl sulfoxide and dimethyl formamide reagents. These experiments provide powerful design rules for rapid, selective, and controlled MOF growth on a variety of substrates, a critical step towards device integration for gas sensing.

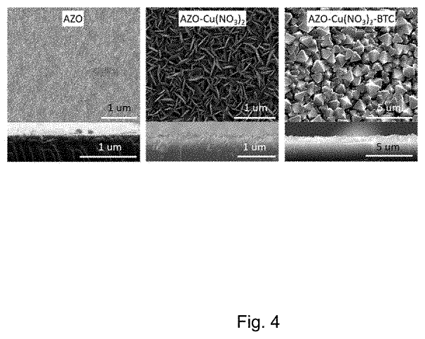

FIG. 4 depict images illustrating MOF film growth. FIG. 4 depicts one exemplary embodiment forming or selecting a substrate. A conductive metal oxide layer (e.q. AZO, aluminum-doped zinc oxide) is formed using a sol-gel precursor solution and then spin-coated or dip coated, then annealed. The conductive metal oxide and template is then dipped into a metal salt ion solution (AZO-Cu(NO₃)₂) forming a hydroxy double salt layer. The hydroxy double salt layer on the template is incubated by dipping in an organic linker solution (AZO-Cu(NO₃)₂-BTC) for example.

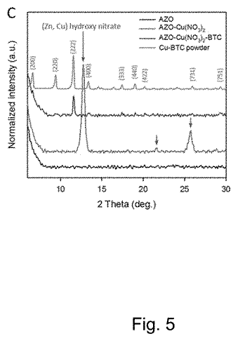

FIG. 5 depicts a graph illustrating XRD patterns confirming the formation of a hydroxy double salt intermediate after metal salt ion solution exposure and Cu-BTC MOF structure following exposure to the BTC organic linker solution.

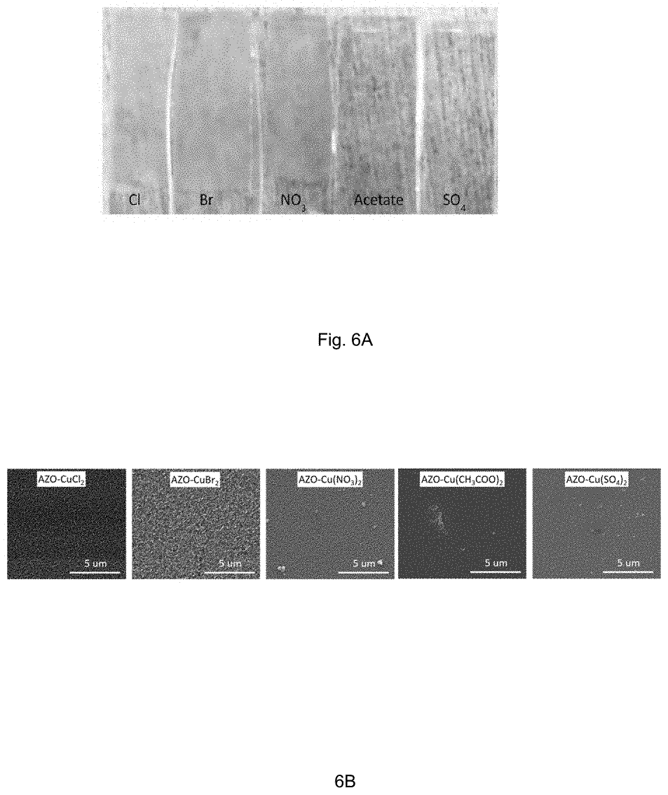

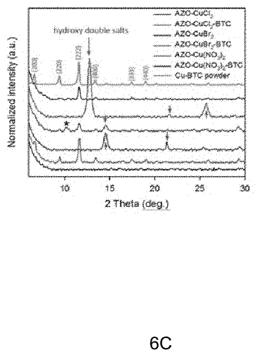

FIGS. 6A-6B depicts images illustrating AZO layer exposure to different metal salt ions. FIG. 6B illustrates Cu-BTC MOF films after exposure to different metal salt ions, including CI, Br, NO₃, CH₃COO and SO₄ Respectively (See FIG. 6A). The graph illustrated in FIG. 6C depicts XRD patterns of hydroxy double layers formed by exposure to AZO-CuCl₂, AZO-CuBr₂, AZO-Cu(NO₃)₂, AZO-Cu(CH₃COO)₂ and AZO-Cu(SO₄)₂, and Cu-BTC MOF structures (illustrated in FIG. 6B) following exposure to BTC organic linker solution.

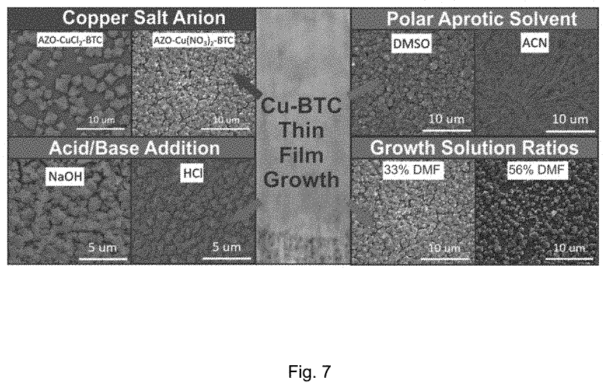

FIG. 7 depicts images illustrating different growth conditions in accordance with one embodiment. More specifically, FIG. 7 depicts different growth conditions, such as metal salt anion, pH, and solvents/ratios. Cu-BTC MOF thin films formed by exposing the conductive metal oxide layer to different copper salt anions (AZO-CuCl₂-BTC and AZO-Cu(NO₃)₂-BTC.) Cu-BTC MOF thin films formed by exposing the conductive metal oxide layer to different pH of metal salt ions. Cu-BTC MOF thin films formed by exposing the hydroxy double salt intermediate to different solvents (DMSO and ACN) used in the organic linker growth solution. Cu-BTC MOF thin films formed by exposing the hydroxy double salt intermediate to different ratios of DMF, ethanol, and water in the organic linker growth solution. It should be appreciated that MOFs may be fined tuned for different sending applications via alterations to the solvents during used growth conditions.

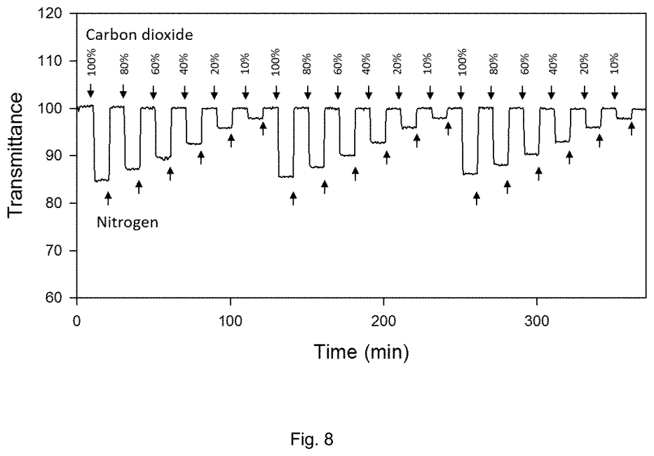

FIG. 8 depicts a graph illustrating dynamic response for different CO₂ concentration on optical fiber sensor coated with MOF film formed by using conductive metal oxide layer and hydroxy double salts.

All publications and patent documents cited in this application are incorporated by reference in their entirety for all purposes to the same extent as if each individual publication or patent document were so individually denoted.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above.

As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted

What is claimed is:

1. A method of forming a sensor, comprising:
forming a template;
forming a hydroxy double salt layer intermediate;
forming a metal-organic framework (MOF) film; and
forming a hybrid MOF/conducting metal oxide structure.

2. The method of claim 1 further comprising using the hybrid MOF/conducting metal oxide structure for optical sensing.

3. The method of claim 2 wherein leveraging the hybrid MOF/conducting metal oxide comprises using only a portion of the total MOF film when forming the hybrid MOF/conducting metal oxide structure.

4. The method of claim 1, further comprising forming at least one of the hydroxy double salt layer intermediate and the MOF film on the template.

5. The method of claim 1, further comprising forming a conductive metal oxide layer prior to forming the hydroxy double salt layer intermediate.

6. The method of claim 1, wherein forming the MOF film comprises incubating the hydroxy double salt layer intermediate in an organic linker.

7. The method of claim 1, further comprising forming the hydroxy double salt layer intermediate and the MOF film at room temperature ranging between about 60 and 80 degrees Fahrenheit.

8. The method of claim 1, further comprising forming the hydroxy double salt layer intermediate and the MOF film on the template during a short reaction time.

9. The method of claim 8, wherein the short reaction time is minutes.

10. The method of claim 1, wherein the MOF film has a uniform, continuous with a controllable thickness.

11. The method of claim 1 further comprising forming the MOF film in a predetermined pattern.

12. The method of claim 1 comprising using the hybrid MOF/conducting metal oxide structure in distributed optical fiber sensors.

13. A method of forming a sensor, comprising:
forming a template;
forming a conductive metal oxide layer on the template;
exposing the conductive metal oxide layer on the template to a metal salt solution;
forming a hydroxy double salt layer on the template; and
incubating the hydroxy double salt layer on the template forming a metal-organic framework (MOF) film on the template.

14. The method of claim 13, further comprising performing the exposing and incubating steps at room temperature ranging between about 60 degrees to about 80 degrees Fahrenheit.

15. The method of claim 13, further comprising performing the exposing and incubating steps during a short reaction time.

16. The method of claim 15, wherein the short reaction time is a few tens of minutes

17. The method of claim 13, further comprising incubating the hydroxy double salt layer intermediate on the template in an organic linker.

18. The method of claim 13, wherein the MOF film is uniform, continuous with a controllable thickness.

19. The method of claim 13 further comprising forming the MOF film in a predetermined pattern.

20. The method of claim 13, converting the hydroxy double salt layer partially forming hybrid MOF/conducting metal oxide layer on optical sensing system.

21. The method of claim 20, wherein forming the hybrid MOF/conducting metal oxide layer which leverages a MOF enhanced surface plasmon resonance-based gas sensing system.

22. The method of claim 13, further comprising forming the MOF thin films on surface acoustic wave-based sensors.

23. The method of claim 13 comprising using the hybrid MOF/conducting metal oxide structure in distributed optical fiber sensors.
